(19) United States
(12) Patent Application Publication
(10) Pub. No.: US 2016/0009895 A1
(43) Pub. Date: Jan. 14, 2016

(54) POLY(VINYL ALCOHOL)-BASED FIBERS HAVING EXCELLENT THERMAL AGING RESISTANCE, AND METHOD FOR PRODUCING SAME

(71) Applicant: KURARAY CO., LTD., Kurashiki-shi (JP)

(72) Inventors: Ryo YAMAMOTO, Okayama-shi (JP); Toshiaki Kobayashi, Okayama-shi (JP); Hideo Hayashi, Okayama-shi (JP)

(73) Assignee: KURARAY CO., LTD., Kurashiki-shi (JP)

(21) Appl. No.: 14/858,570

(22) Filed: Sep. 18, 2015

Related U.S. Application Data
(63) Continuation of application No. PCT/JP2014/055857, filed on Mar. 6, 2014.

(30) Foreign Application Priority Data
Mar. 29, 2013 (JP) 2013-071106

(51) Int. Cl. C08K 3/38; C08K 3/16

(52) U.S. Cl. CPC C08K 3/38; C08K 3/16

(57) ABSTRACT

Polyvinyl alcohol fibers containing: 0.05% by mass of an antioxidant composed of an inorganic or organic water soluble salt of at least one metal selected from the group consisting of manganese, copper, iron, nickel, cobalt, and zinc; and a boron compound that acts as a chelating agent for the antioxidant, the boron compound being contained in the fiber with a proportion in % by mass of 0.5% or more relative to the antioxidant.

### CROSS REFERENCE TO RELATED APPLICATION

This application is a continuation application, under 35 U.S.C. §111(a), of international application No. PCT/JP2014/055857, filed Mar. 6, 2014, which claims priority to Japanese Patent Application No. 2013-071106 filed on Mar. 29, 2013, the entire content of which is herein incorporated by reference as a part of this application.

### FIELD OF THE INVENTION

The present invention relates to poly(vinyl alcohol)-based fibers (polyvinyl alcohol fibers) having excellent heat aging resistance even when the fibers are used for a long time under a high temperature environment, and to a method for producing the same.

### BACKGROUND ART

Polyvinyl alcohol fibers (PVA fibers) have excellent tenacity, elasticity, chemical resistance, and adhesiveness, and therefore, are widely used as various industrial materials including reinforcing material in rubber, asbestos-alternative as reinforcing material in cements or concretes, separators in alkaline batteries (dry cell), ropes, and fishing nets.

In general, PVA fibers have been known to exhibit brown coloration due to oxidative degradation of PVA by heat treatment at a high temperature. Patent Document 1 (Japanese Examined Patent Publication No. S35-1669) discloses a method for inhibiting coloration of polyvinyl alcohol fibers and a molded article thereof during heat treatment, including: adding one or two or more of inorganic or organic water soluble metallic salt into a spinning solution or into a coagulation bath such that the salt is contained in the PVA fibers or the molded article in an amount of 1% or less, where the metallic salt is a salt of a metal selected from the groups of metals ranging from titanium to copper in periodic table or of tin and lead; or dipping spun PVA fibers or a molded article thereof in a bath containing the metallic salt such that the salt is contained in the PVA fibers or the molded article in an amount of 1% or less, and subsequently drying and heat treating the fibers or the article.

Patent Document 2 (Japanese Examined Patent Publication No.S45-7691) discloses a method of achieving PVA synthetic fibers having excellent thermal stability and a product thereof by making the PVA synthetic fibers and the product thereof to contain one or two or more of thiazoles compound or imidazolines compound each having a mercapto group in the molecular structure.

In this document, the thiazoles compound or imidazolines compound each having a mercapto group in the molecular structure is used as a reducing agent. For example, Examples of this document describes a reduction ratio of tenacity by a heat treatment at 140° C. for 96 hours is controlled to the range of 16.8 to 26.7%.

With respect to linier polymers that generally exhibit deterioration such as discoloration and tenacity reduction by being heated to a high temperature, Patent Document 3 (Japanese Examined Patent Publication No. S38-22720) discloses a linier polymer composition that has excellent thermal stability and contains: 2-mercaptoimidazoles and metallic salts capable of forming poorly water soluble complex salts with the 2-mercaptimidazoles; poorly water soluble complex salt achieved from the 2-mercaptimidazoles and the metallic salt; or the 2-mercaptimidazoles and the poorly water soluble complex salt.

For example, in Example 3 of this document, the 2-mercaptoimidazoles and the metallic salts capable of forming poorly water soluble complex salts with the 2-mercaptimidazoles are combined to improve thermal stability of PVA fibers under heat treatment at 140° C. for 70 hours.

### SUMMARY OF THE INVENTION

However, Patent Document 1 only describes prevention of coloration due to heat treatment during production process of fibers.

Although Patent Document 2 and Patent Document 3 describe the use of fibers under high temperature conditions for about 100 hours, heat aging resistance that enables the use for still longer time is demanded.

Therefore, an object of the present invention is to provide polyvinyl alcohol fibers having excellent heat aging resistance capable of suppressing significant reduction of tenacity even when the fibers are used under high temperature conditions for a very long time beyond the expectation based on the conventional knowledge.

As a result of extensive research for achieving the above-described object, the inventors confirmed that heat aging resistance for a long time could not be improved by the metallic salt used as an antioxidant for preventing coloration. As a result of further research, the inventors found that heat aging resistance of PVA fibers under high temperature conditions for a long duration beyond the conventionally achievable range can be surprisingly achieved by combining a boron compound with the antioxidant in a specific proportion, and achieved the present invention.

A first aspect of the present invention is PVA fibers having excellent heat aging resistance, containing:
an antioxidant composed of an inorganic or organic water soluble salt of at least one metal selected from the group consisting of manganese, copper, iron, nickel, cobalt, and zinc; and
a boron compound that acts as a chelating agent for the antioxidant,
wherein the content of the antioxidant in the fiber is 0.05% by mass or more (for example, 0.05 to 10% by mass), and a proportion (mass ratio in %) of the boron compound relative to a mass of the antioxidant is 0.5% by mass or more (for example, 0.5 to 60% by mass).

The boron compound may be at least one selected from boric acid and borates. Preferably, the antioxidant is a metal halide. Preferably, the antioxidant is at least one selected from the group consisting of manganese chloride, copper chloride, iron chloride, nickel chloride, and cobalt chloride, where the manganese chloride is specifically preferred.

The above-described polyvinyl alcohol fibers may further contain sodium chloride as a stabilizer for the antioxidant. For example, proportion of the sodium chloride to the antioxidant may be about 5 to 50% by mass.

The above-described polyvinyl alcohol based fiber has excellent heat aging resistance for a long duration. For example, the fiber may have a tenacity retention (retention rate of residual tenacity) of 60% or more after a heat treatment at 150° C. for 400 hours.

The above-described polyvinyl alcohol based fiber may be advantageously used, for example, as a reinforcing material in a rubber.

A second aspect of the present invention is a method for producing the above-described polyvinyl alcohol fibers, at least including:
performing spinning of fibers from a spinning solution containing polyvinyl alcohol based polymer,
wherein the antioxidant is added into the spinning solution or the antioxidant is added to the polyvinyl alcohol based fiber after the spinning in a form of a solution or a dispersion of the antioxidant, and
the boron compound is added into the spinning solution or applied to the fibers after the spinning by a form of a solution or a dispersion of the boron compound.

For example, the antioxidant and the boron compound may be preferably applied to the polyvinyl alcohol based fiber after the spinning.

The above-described production method may further comprises drawing of the fibers performed after the spinning, and the antioxidant and the boron compound may be applied to the polyvinyl alcohol based fiber after the drawing.

The boron compound may be applied to the fibers after applying the antioxidant to the fiber after the spinning or the drawing of the fibers.

In the description of the present invention, converted mass of the metallic salt is calculated as a mass of an anhydride even when the metallic salt is used in the form of hydrate.

It should be noted that the present invention encompasses any combination of at least to constitutions disclosed in the claims and/or the specification. Specifically, the present invention encompasses any combination of two or more claims.

According to the present invention, by the use of specific antioxidant and boron compound that is combined with the antioxidant in a specific proportion as a chelating agent for the antioxidant, it is possible to achieve PVA fibers exhibiting excellent tenacity retention under high temperature conditions for a long period of time that is beyond the expectation based on the prior art.

### MODE FOR CARRYING OUT THE INVENTION

According to the method for producing PVA fibers of the present invention, it is possible to produce PVA fibers having the above-described heat aging resistance while using a simple and easy method.

Hereafter, practical explanation of the present invention will be provided.

### Polyvinyl Alcohol Based Fiber

A first embodiment of the present invention relates to PVA fibers having excellent heat aging resistance, the PVA fibers including: an antioxidant composed of an inorganic or organic water soluble salt of at least one metal selected from the group consisting of manganese, copper, iron, nickel, cobalt, and zinc; and a boron compound that acts as a chelating agent for the antioxidant.

The antioxidant is contained in the fiber in an amount of 0.05% by mass or more, and a proportion of the boron compound to the antioxidant is 0.5% by mass or more.

### Antioxidant

The antioxidant is composed of an inorganic or organic water soluble salt of at least one metal selected from the group consisting of manganese, copper, iron, nickel, cobalt, and zinc. The antioxidant may be substantially composed of inorganic or organic water soluble salt of at least one metal selected from the group consisting of manganese, copper, iron, nickel, cobalt, and zinc. Among these metallic compound, manganese, copper, iron, nickel, cobalt or the like are preferred as the metal, where manganese is specifically preferred.

Only one selected from the above-described antioxidants may be used. Alternatively, two or more antioxidants may be used in combination.

As an acid residue (acid radical) constituting the inorganic water soluble metallic salt, it is possible to use sulfuric acid, nitric acid, phosphoric acid, and halide acid (for example, hydrofluoric acid, hydrochloric acid, oxalic acid, and hydroiodic acid). As an acid residue (acid radical) constituting the organic water soluble metallic salt, it is possible to use formic acid, oxalic acid, acetic acid, benzoic acid, or the like.
Among the above-described metallic salts, inorganic water soluble metallic salt is preferred, where metal halide is preferably used. Manganese halide, copper halide, iron halide, nickel halide, cobalt halide are preferred as the metal halide. Specifically, manganese chloride, copper chloride, iron chloride, nickel chloride, and cobalt chloride are preferably used.
In order to provide heat aging resistance for a long time, the antioxidant must be contained in the PVA fibers in an amount of 0.05% by mass or more. Preferably the content of the antioxidant may be 0.07% by mass or more, more preferably 0.1% by mass or more.

The mass of the PVA fibers may be defined as a mass at a state where the PVA fibers are dipped in water, subjecting the fibers to centrifugal hydro-extraction, and subsequently air drying the fibers at about 20° C. for 16 to 20 hours.

The upper limit of the proportion of the antioxidant composed of the metallic salt is not specifically limited provided that PVA fibers having excellent heat aging resistance can be produced. Based on the consideration of processability or the like, proportion of the antioxidant in the fiber may be about 10% by mass or less, 5% by mass or less, or 2% by mass or less.

### Boron Compound

In the present invention, it is very important to use a boron compound as a chelating agent for the antioxidant. Conventionally, organic aminocarboxylate such as EDTA has been generally used as a chelating agent. Such a chelating agent is bonded with metal ions by coordinate bonding to form complex ions thereby sequestering the metal ions. However, the heat aging cannot be suppressed by combining the conventional chelating agent with the antioxidant. In the present invention, surprisingly, it was found that heat aging resistance of PVA fibers can be achieved for a long time period far longer than the conventionally achievable time period by combining the boron compound, in a predetermined proportion, with the above-described antioxidant composed of metallic salt.

Species of the boron compound is not specifically limited as long as it acts as a chelating agent for the antioxidant. For example, boric acids, boric acid esters, borates, boronhydride or the like may be used. It is possible to use single species or a combination of two or more species selected from these compounds. Orthoboric acid, metaboric acid, and tetraboric acid may be used as the boric acids. Boric acid triethyl esters, boric acid trimethyl esters or the like may be used as the boric acid esters. Alkaline metal salts or alkaline earth metal salts of the above described various boric acids, borax or the like may be used as the borates. Among these compounds, orthoboric acids (hereafter occasionally referred to as boric acid) and borates are preferred.

Proportion (in % by mass) of the boron compound must be 0.5% by mass or more based on the antioxidant (that is, amount of the boron compound is 0.5 parts by mass relative to 100 parts by mass of the antioxidant), preferably 1% by mass or more, more preferably 1.5% by mass or more. Where the proportion of the antioxidant combined with the boron compound is less than 0.5% by mass, the boron compound cannot provide sufficient contribution as a chelating agent, resulting in failure to achieve heat aging resistance for a long time.

The upper limit of the proportion of the boron compound to the antioxidant is not particularly limited provided that PVA fibers having excellent heat aging resistance can be produced. For example, in order to retain satisfactory applicability as a rubber reinforcing material, proportion of the boron compound combined with the antioxidant may be 60% by mass or less, or 55% by mass or less.

Where necessary, the fibers may contain sodium chloride. Where the sodium chloride is further combined with the antioxidant and the boron compound used in the present invention, it is preferred since the heat aging resistance of the fiber can be further improved.

In the above-described Patent Documents 1 and 2, sodium chloride itself is recognized as a material the use of which has no contribution to prevent oxidation of the PVA fibers. However, possibly due to contribution of sodium chloride as a stabilizer for the antioxidant, heat aging resistance of the PVA fibers can be improved by the addition of the sodium chloride.

Proportion (in % by mass) of the sodium chloride to the antioxidant may be about 5 to 50% by mass (that is, amount of sodium chloride may be about 5 to 50 parts by mass per 100 parts by mass of the antioxidant), preferably about 10 to 50% by mass, more preferably about 15 to 50% by mass.

### Production Method of PVA Fibers

A second embodiment of the present invention is a method for producing PVA fibers, the method at least including:
performing spinning of fibers from spinning solution containing PVA polymer,
wherein an antioxidant is added into the spinning solution or applied to (made adhere to) the PVA spun fibers (PVA fibers after spinning) by a form of a solution or a dispersion of the antioxidant, and
an boron compound is added into the spinning solution or applied to the PVA spun fibers by a form of a solution or a dispersion of the boron compound.

The PVA fibers used in the present invention are composed of a PVA-based polymer.

The PVA-based polymer is not particularly limited provided that the polymer is mainly composed of vinyl alcohol units. If desired, different structural units (modifying units) may be contained as long as the effect of the present invention is not deteriorated. For example, candidates for such structural units include olefins (for example, ethylene, propylene, butylene or the like), acrylic acids (for example, acrylic acid and a salt thereof, acrylic acid esters such as methyl acrylate), methacrylic acids (for example, methacrylic acid and a salt thereof, methacrylic acid esters such as methyl methacrylate), acrylic amides (for example, acrylic amide, N-methyl acrylic amide or the like), methacrylic amides (for example, methacryl amide, N-methylol methacryl amide or the like), N-vinyl lactams (for example, N-vinyl pyrrolidone or the like), N-vinyl amides (for example, N-vinyl formamide, N-vinyl acetoamide, or the like), vinyl ethers (for example, allylethers having polyalkylene oxide in the side chain, methyl vinyl ethers or the like), nitriles (for example, acrylonitrile or the like), vinyl halide compounds (vinyl chloride or the like), and unsaturated dicarboxylic acids (for example, maleic acid, and salt, anhydride, or ester thereof, or the like). It is possible to use single species or combination of species selected from the above-described modifying units. Those modifying units may be introduced into the PVA-based polymer by copolymerization or by post-polymerization reaction.

Proportion (molar ratio) of the modifying units to the vinyl alcohol units satisfy [vinyl alcohol units]/[modifying units]=about 85/15 to about 100/0, preferably about 88/12 to about 99/1, more preferably about 90/10 to about 98/2.

In accordance with the purpose, the polymer may further contain one or a combination of additives such as a flame retardant, an anti-freezing agent, a pH regulator, a masking agent, a coloring agent, an oil agent, a special functional agent or the like in an amount not disturbing the effect of the invention. Degree of polymerization of the PVA-based polymer constituting the

PVA fiber is not particularly limited, and may be selected in accordance with the purpose of its application. Based on the consideration of mechanical properties, heat aging resistance of the achieved fibers, average degree of polymerization of the PVA-based polymer determined based on the viscosity of aqueous solution at 30° C. is preferably about 500 to about 20000 (preferably about 800 to about 15000, more preferably about 1000 to about 10000). While the polymer of high degree of polymerization is preferably used because of its excellent tenacity, heat aging resistance or the like, the average degree of polymerization may be about 1200 or more and about 2500 or less (preferably 1300 or more and 2400 or less) based on the consideration of polymer production cost, fiber production cost or the like.

The degree of saponification of the PVA-based polymer constituting the PVA fibers is not particularly limited, and may be selected in accordance with the purpose of its application. For example, the degree of saponification may be 88 mole % or more, preferably 90 mole % or more, more preferably 95 mole % or more based on the consideration of mechanical properties of the achieved fiber. In many case, too low saponification degree of the PVA based polymer is not preferred in terms of mechanical strength, processability, production cost or the like of the achieved fibers.

The PVA fibers used in the present invention may be achieved by dissolving such PVA-based polymer in a solvent, spinning fibers by any of wet spinning, dry wet spinning, and dry method, and drawing the spun fibers under dry heat. Among these fibers, fibers achieved by dry spinning are preferred.

In the production process of the PVA fibers, it is possible to use one or a combination of two or more of conventionally used solvents, for example, water, dimethyl sulfoxide (DMSO), dimethyl formamide, dimethyl acetamide, polyhydric alcohols such as glycerin, ethylene glycol, and triethylene glycol, or the like. Among these solvents, water and/or DMSO are specifically preferred based on the consideration of suppliability and influence on the environmental load. While a concentration of the polymer in the spinning solution varies in accordance with the composition and degree of polymerization of the PVA-based polymer, and species of solvent, the concentration is in the range of 6 to 60% by mass in general cases.

As long as the effect of the present invention is not deteriorated, the spinning solution may contain an additive (or additives) other than the PVA-based polymer. In accordance with the purpose, the additive (additives) may be selected from a surfactant, a decomposition inhibitor, an antifreezing agent, a pH regulator, a masking agent, a coloring agents, an oil agent, or the like.

Where necessary, the PVA fibers according to the present invention may be subjected to drawing after the spinning. In addition, the PVA fibers may be subjected to general treatment for PVA fibers, for example, acetalization.

The antioxidant and/or the boron compound may be added to the spinning solution of PVA. Alternatively, solution or dispersion of the antioxidant (liquid A) an/or solution or dispersion of the boron compound (liquid B) may be applied to the PVA fibers (spun fibers) by post-spinning treatment such as impregnation, coating, or the like. As long as the heat aging resistance can be improved, the liquid A and liquid B may be added to the fiber simultaneously, or one by one separately. In order to achieve satisfactory handleability of the PVA-based polymer in the spinning process, the antioxidant and the boron compound may be added to the polyvinyl alcohol fibers after the spinning.

Where the production method includes the drawing performed after the spinning, the antioxidant and the boron compound are preferably applied to the polyvinyl alcohol fibers after drawing. Specifically, the antioxidant and the boron compound may be added to the polyvinyl alcohol fibers after the post-spinning treatments such as acetalization and staining so as to avoid drop out of the antioxidant and/or the boron compound during the post-spinning treatment. In this case, the antioxidant and the boron compound may be added in the form of solution or dispersion of the antioxidant (liquid A) and solution or dispersion of the boron compound (liquid B) by impregnation or by coating (for example, roller coating) or the like.

Where the liquid A and liquid B are applied to the fibers separately, it is preferable to make the boron compound adhere to the fibers after making the antioxidant adhere to the fiber after the spinning or after drawing. In this case, it is possible to enhance chelating performance of the boron compound for the antioxidant.

### PVA Fibers

The PVA fibers according to the present invention exhibit excellent heat aging resistance for a long period of time that could not be achieved in the conventional art. For example, as an indication of the heat aging resistance, the PVA fibers of the present invention may have tenacity retention (retention rate of residual tenacity) of 60% or more, preferably 65% or more, more preferably 70% or more after the heat treatment of the fiber at 150° C. for 400 hours. The tenacity retention denotes a value determined by a method described in the below-described Examples.

Single fiber fineness of the PVA fibers may be varied depending on the use and purpose. For example, the single fiber fineness may be about 0.1 to about 10 dtex, preferably about 1 to about 7 dtex. The PVA fibers may be used in various forms including filaments, cut fibers (crimped fiber or the like), spun yarns, strings, braids, ropes, fabrics (non-woven fabrics, woven or knitted fabrics), or the like. Where necessary, the PVA fibers may be used in combination with different fibers.

The above-described PVA fibers can be satisfactorily used as reinforcing material in plastics, cements, and rubber materials such as tires, vehicle hoses (radiator hoses, oil brake hoses), and conveyer belts, and industrial material such as ropes, canvases, tents, fishing nets, land nets, and geotextiles.

### EXAMPLES

Hereafter, the present invention will be explained more in detail with reference to the examples, while it should be noted that the present invention is not limited by these examples.

### Amount of Antioxidant

PVA fibers of 1 g were weighed precisely. After ashing the fibers by incineration method, the obtained ash was diluted by aqueous solution of nitric acid. The solution was analyzed by atomic absorption spectroscopy, and an amount of manganese applied to the fibers was calculated from calibration curve. Amount of manganese chloride contained as an antioxidant was calculated from this result.

With respect to the antioxidants other than the manganese chloride, it was estimated that similar amount of antioxidant was applied to the fibers by the use of similar concentration in the solution as in the solution used for adhering the manganese chloride.

### Amount of Boron Compound

PVA fibers were dissolved in water of 140° C. in a sealed condition. Mannite (product of KANTO CHEMICAL CO., INC.), chemical that easily reacts with boron, was added to the solution, and an amount of boric acid applied to the fibers was determined by titration with NaOH.

With respect to chelating agent other than the boric acid, it was estimated that the amount of adhesion was similar to that of boric acid when a concentration in the solution was similar to the boric acid concentration in the solution used for adhering the boric acid.

### Amount of Sodium Chloride

Since the sodium chloride was applied to the fibers using the same water bath as the manganese chloride while reducing the concentration, the amount of adhesion was calculated from the amount of the manganese chloride estimating that the amount was proportional to the concentration ratio.

### Tenacity Retention

A yarn in a tensionless state was introduced in a hot-air oven. Tenacity of the yarn was measured after heating the yarn for 100 hours, and after heating the yarn for 400 hours at 150° C. Retention rate (in %) of the tenacity relative to the tenacity of the yarn before the heating was calculated. The tenacity of the yarn was measured in accordance with JIS L1013.

### Example 1

An aqueous solution containing, in an amount excluding crystal water, 5 g/L of manganese (II) chloride tetrahydrate (Wako Pure Chemical Industries, Ltd.) and 1 g/L of sodium chloride (Wako Pure Chemical Industries, Ltd) was prepared. PVA fibers (Vinylon 1239 (1333 dtex/200 f), a product of KURARAY CO., LTD.) were dipped in the solution and left in the solution for 30 minutes at 60° C. After that, surface water was removed from the PVA fibers by centrifugal dewatering. After that, the fibers were air-dried for 16 to 20 hours at about 20° C.

Next, the above-described fibers treated with the antioxidant were dipped in an aqueous solution containing 0.1 g/L of boric acid (Wako Pure Chemical Industries, Ltd), and left in the solution for 30 minutes at 60° C. After that, surface water was removed from the fibers by centrifugal dewatering, and the fibers were subsequently air-dried for 16 to 20 hours at about 20° C. Thus, PVA fibers adhered with manganese chloride as antioxidant and boric acid as chelating agent were obtained. The thus obtained PVA fibers were added with antioxidant and boron compound, and were calculated to be added with the sodium chloride as a stabilizing agent in the proportions shown in Table 1. Tenacity retention of the thus achieved fibers is shown in Table 1.

### Example 2

PVA fibers were obtained in the same manner as in Example 1 except that boric acid concentration in the solution was 1 g/L. The thus obtained PVA fibers were added with antioxidant and boron compound, and were calculated to be added with the sodium chloride as a stabilizing agent in the proportions shown in Table 1. Tenacity retention of the thus achieved fibers is shown in Table 1.

### Example 3

PVA-based fibers were obtained in the same manner as in Example 1 except that concentration of the antioxidant was 10 g/L, concentration of sodium chloride was 2 g/L, and concentration of boric acid was 1 g/L. The thus achieved PVA fibers were added with antioxidant and boron compound, and were calculated to be added with the sodium chloride as a stabilizing agent in the proportions shown in Table 1. Tenacity retention of the thus achieved fibers is shown in Table 1.

### Example 4

PVA fibers were obtained in the same manner as in Example 1 except that concentration of the antioxidant was 10 g/L, concentration of sodium chloride was 2 g/L, and concentration of boric acid was 5 g/L. The thus achieved PVA fibers were added with antioxidant and boron compound, and were calculated to be added with the sodium chloride as a stabilizing agent in the proportions shown in Table 1. Tenacity retention of the thus achieved fibers is shown in Table 1.

### Examples 5 to 8

In Examples 5 to 8, PVA fibers were obtained in the same manner as in Example 1 except that the antioxidant was replaced to one of copper chloride, iron chloride, nickel chloride, and cobalt chloride respectively. The thus obtained PVA fibers were added with antioxidant and boron compound, and were calculated to be added with the sodium chloride as a stabilizing agent in the proportions shown in Table 1. Tenacity retention of the thus achieved fibers is shown in Table 1.

### Example 9

An aqueous solution containing, in an amount excluding crystal water, 50 g/L of manganese chloride was prepared. PVA fibers (Vinylon 1239 (1333 dtex/200 f), a product of KURARAY CO., LTD.) were dipped in the solution and left in the solution for 30 minutes at 60° C. After that, surface water was removed from the PVA fibers by centrifugal dewatering, and the fibers were air-dried for 16 to 20 hours at about 20° C.

Next, the above-described fibers treated with the antioxidant was dipped in an aqueous solution containing 50 g/L of boric acid (Wako Pure Chemical Industries, Ltd), and left in the solution for 30 minutes at 60° C. After that, surface water was removed from the fibers by centrifugal dewatering, and the fibers were subsequently air-dried for 16 to 20 hours at 20° C. Thus, PVA fibers adhered with manganese chloride as antioxidant and boric acid as chelating agent were obtained. The thus obtained PVA fibers were added with antioxidant and boron compound in the proportions shown in Table 1. Tenacity retention of the thus achieved fibers is shown in Table 1.

### Comparative Example 1

Fibers were obtained in the same manner as in Example 1 except that antioxidant and chelating agent and stabilizing agent were not used. Tenacity retention of the thus achieved fibers is shown in Table 1.

### Comparative Example 2

Fibers were obtained in the same manner as in Example 1 except that antioxidant and stabilizing agent were not used. It was calculated that the thus obtained PVA fibers were added with chelating agent in a proportion as shown in Table 1. Tenacity retention of the thus achieved fibers is shown in Table 1.

### Comparative Example 3

Fibers were obtained in the same manner as in Example 1 except that 2-mercaptobenzimidazole in a concentration of 5 g/L was used as the antioxidant and that chelating agent and stabilizing agent were not used. It was calculated that the thus obtained PVA fibers were added with the antioxidant in a proportion as shown in Table 1. Tenacity retention of the thus achieved fibers is shown in Table 1.

### Comparative Example 4

Fibers were obtained in the same manner as in Example 1 except that dibutylhydroxytoluene (BHT) in a concentration of 5 g/L was used as the antioxidant and chelating agent and stabilizing agent were not used. It was calculated that the thus obtained PVA fibers were added with the antioxidant in a proportion as shown in Table 1. Tenacity retention of the thus achieved fibers is shown in Table 1.

### Comparative Example 5

Fibers were obtained in the same manner as in Example 1 except that dibutylhydroxytoluene (BHT) in a concentration of 5 g/L was used as the antioxidant and boric acid in a concentration of 0.1 g/L was used as the chelating agent. Stabilizing agent was not used. Tenacity retention of the thus achieved fibers is shown in Table 1.

### Comparative Example 6

Fibers were obtained in the same manner as in Example 1 except that chelating agent was not used. The thus obtained PVA fibers were added with the antioxidant and were calculated to be added with the sodium chloride in proportions as shown in Table 1. Tenacity retention of the thus achieved fibers is shown in Table 1.

### Comparative Example 7

Fibers were obtained in the same manner as in Example 1 except that sodium citrate in a concentration of 1 g/L was used as the chelating agent. The thus obtained PVA fibers were added with the antioxidant in a proportion as shown in Table 1. In addition, the fibers were calculated to be added with the chelating agent and sodium chloride in proportions as shown in Table 1. Tenacity retention of the thus achieved fibers is shown in Table 1.

### Comparative Example 8

Fibers were obtained in the same manner as in Example 1 except that EDTA in a concentration of 1 g/L was used as the chelating agent. The thus obtained PVA fibers were added with the antioxidant in a proportion as shown in Table 1. In addition, the fibers were calculated to be added with the chelating agent and sodium chloride in proportions as shown in Table 1. Tenacity retention of the thus achieved fibers is shown in Table 1.

### Comparative Example 9

Fibers were obtained in the same manner as in Example 1 except that the concentration of boric acid was 0.01 g/L. The thus obtained PVA fibers were added with the antioxidant and boron compound, and were calculated to be added with sodium chloride in a proportion as shown in Table 1. Tenacity retention of the thus achieved fibers is shown in Table 1.

TABLE 1

| | | | | | | | | | | | Stabilizer | | |
|---|---|---|---|---|---|---|---|---|---|---|---|---|---|
| | | | | | | | | | | | (% by mass | | |
| | | | | | | | | Chelating agent | | | relative to | | |
| | Antioxidant | | | | | | | (% by mass: relative to | | | the mass of | Tenacity | |
| | (% by mass: relative to the mass of fibers) | | | | | | | the mass of antioxidant) | | | antioxidant) | retention | |
| | Manganese | Copper | Iron | Nickel | Cobalt | 2-mercapto- | | | Sodium | | Sodium | (%) | |
| | chloride | chloride | chloride | chloride | chloride | benzimidazole | BHT | Boric acid | citrate | EDTA | chrolide | 100 h | 400 h |
| Example 1 | 0.1 | — | — | — | — | — | — | 2 | — | — | 20 | 92 | 67 |
| Example 2 | 0.1 | — | — | — | — | — | — | 20 | — | — | 20 | 98 | 69 |
| Example 3 | 0.2 | — | — | — | — | — | — | 10 | — | — | 20 | 95 | 75 |
| Example 4 | 0.2 | — | — | — | — | — | — | 50 | — | — | 20 | 95 | 75 |
| Example 5 | — | 0.1 | — | — | — | — | — | 2 | — | — | 20 | 90 | 70 |
| Example 6 | — | — | 0.1 | — | — | — | — | 2 | — | — | 20 | 87 | 65 |
| Example 7 | — | — | — | 0.1 | — | — | — | 2 | — | — | 20 | 88 | 62 |
| Example 8 | — | — | — | — | 0.1 | — | — | 2 | — | — | 20 | 85 | 67 |
| Example 9 | 1 | — | — | — | — | — | — | 50 | — | — | — | 90 | 60 |
| Com. Ex. 1 | — | — | — | — | — | — | — | — | — | — | — | 54 | 18 |
| Com. Ex. 2 | — | — | — | — | — | — | — | 2 | — | — | — | 54 | 18 |
| Com. Ex. 3 | — | — | — | — | — | 0.1 | — | — | — | — | — | 53 | 18 |
| Com. Ex. 4 | — | — | — | — | — | — | 0.1 | — | — | — | — | 53 | 18 |
| Com. Ex. 5 | — | — | — | — | — | — | 0.1 | 2 | — | — | — | 54 | 18 |
| Com. Ex. 6 | 0.1 | — | — | — | — | — | — | — | — | — | 20 | 91 | 30 |
| Com. Ex. 7 | 0.1 | — | — | — | — | — | — | — | 20 | — | 20 | 77 | 25 |
| Com. Ex. 8 | 0.1 | — | — | — | — | — | — | — | — | 20 | 20 | 79 | 30 |
| Com. Ex. 9 | 0.1 | — | — | — | — | — | — | 0.2 | — | — | 20 | 95 | 45 |

As shown in Table 1, samples after the treatment for 100 hours showed difference in tenacity retention. Even the fibers that did not show distinguishable difference in tenacity retention after 100 hours showed remarkable difference in tenacity retention after the treatment for 400 hours.

More specifically, in Comparative Example 1, without using antioxidant, the residual tenacity was reduced to about half the value after the treatment at 150° C. for 100 hours, and only 18% of the tenacity before the treatment is retained after the treatment at 150° C. for 400 hours. In Comparative Example 2 where the fibers were adhered only with boric acid as chelating agent without using the antioxidant, the residual tenacity was reduced to about half the value after the treatment at 150° C. for 100 hours, and only 18% of the tenacity before the treatment is retained after the treatment at 150° C. for 400 hours. In Comparative Examples 3 and 4, the residual tenacity of the fibers was reduced to about half the original value after the treatment for 100 hours, even though 2-mercaptobenzimidazole and BHT used in these fibers were reported as antioxidants. As shown in Comparative Example 5, the residual tenacity of the fibers was reduced to about half the original value after the treatment for 100 hours, even when boric acid was used as a chelating agent for BHT.

In Comparative Example 6 using manganese chloride as the antioxidant, residual tenacity of the fibers was substantially the same level as those of the inventive examples after the treatment at 150° C. for 100 hours, but the residual tenacity was reduced largely after the treatment for 400 hours due to lack of boric acid as a chelating agent.

In Comparative Example 9 using manganese chloride as an antioxidant, residual tenacity of the fibers was substantially the same level as those of the inventive examples after the treatment at 150° C. for 100 hours, but the residual tenacity was reduced largely after the treatment for 400° C. since the amount of boric acid was too small.

In Comparative Examples 7 and 8 using chelating agent other than the boric acid, the residual tenacity of the fibers was reduced to about half the value after the treatment at 150° C. for 100 hours, and the residual tenacity was reduced remarkably after the treatment for 400 hours. On the other hand, in PVA fibers of each of Examples 1 to 9, fibers after the treatment at 150° C. for 100 hours show tenacity retention of 85% or more of the value before the heat treatment. Fibers after the treatment at 400 hours show tenacity retention of 60% or more of the value before the heat treatment, where Examples 3 and 4 using relatively large amount of antioxidant specifically show tenacity retention of 70% or more of the value before the heat treatment.

### INDUSTRIAL APPLICABILITY

Since the PVA fibers according to the present invention can retain their tenacity for a long period of time, the fibers can be satisfactorily used as reinforcing material in plastics, cements, and rubber materials such as tires, vehicle hoses (radiator hose, oil brake hose), and conveyer belts, and industrial material such as ropes, canvases, tents, fishing nets, land nets, and geotextiles.

While satisfactory examples are explained above, a person of ordinary skill in the art will easily recognize various changes and modifications that are obvious from the description of this invention.

Therefore, such changes and modifications are regarded to be included in the scope of the invention defined by claims.

What is claimed is:

1. Polyvinyl alcohol fibers containing:
0.05% by mass or more of an antioxidant composed of an inorganic or organic water soluble salt of at least one metal selected from the group consisting of manganese, copper, iron, nickel, cobalt, and zinc; and
a boron compound that acts as a chelating agent for the antioxidant, the boron compound being contained in the fibers with a proportion in % by mass of 0.5% or more relative to the antioxidant.

2. Polyvinyl alcohol fibers according to claim 1,
wherein the fibers contain 0.05 to 10% by mass of the antioxidant, and the proportion of the boron compound relative to the antioxidant is 0.5% to 60% by mass.

3. Polyvinyl alcohol fibers according to claim 1, wherein the boron compound is at least one selected from the group consisting of boric acid and borates.

4. Polyvinyl alcohol fibers according to claim 1, wherein the antioxidant is a metal halide.

5. Polyvinyl alcohol fibers according to claim 1, wherein the antioxidant is at least one selected from the group consisting of manganese chloride, copper chloride, iron chloride, nickel chloride, and cobalt chloride.

6. Polyvinyl alcohol fibers according to claim 1, wherein the antioxidant is manganese chloride.

7. Polyvinyl alcohol fibers according to claim 1, further containing sodium chloride as a stabilizer for the antioxidant.

8. Polyvinyl alcohol fibers according to claim 7, wherein the proportion of the sodium chloride to the antioxidant is 5 to 50% by mass.

9. Polyvinyl alcohol fibers according to claim 1, wherein tenacity retention after a treatment at 150° C. for 400 hours is 60% or more.

10. Polyvinyl alcohol fibers according to claim 1, wherein the fibers are used for reinforcing a rubber product.

11. A method of producing polyvinyl alcohol fibers as recited in claim 1, at least comprising:
performing spinning of fibers from a spinning solution containing polyvinyl alcohol based polymer,
wherein the antioxidant is added into the spinning solution or applied to the polyvinyl alcohol fibers after spinning by a form of a solution or a dispersion of the antioxidant, and
the boron compound is added into the spinning solution or applied to the polyvinyl alcohol fibers after spinning by a form of a solution or a dispersion of the boron compound.

12. The method for producing polyvinyl alcohol fibers according to claim 11, wherein the antioxidant and the boron compound are added to the polyvinyl alcohol fibers after the spinning.

13. The method for producing polyvinyl alcohol fibers according to claim 11, further comprising drawing of the fibers performed after the spinning, wherein the antioxidant and the boron compound are added to the polyvinyl alcohol fibers after the drawing.

14. The method according to claim 11, wherein the boron compound is applied to the fiber after applying the antioxidant to the spun fiber or the drawn fiber.
